(19) United States
(12) Patent Application Publication
(10) Pub. No.: US 2025/0188838 A1
(43) Pub. Date: Jun. 12, 2025

(54) INDEXABLE EARTH CUTTING TOOL ASSEMBLY

(71) Applicant: Kennametal Inc., Latrobe, PA (US)

(72) Inventors: Jacob Poremski, Apollo, PA (US); James Geyer, Manns Choice, PA (US); Jerry Pacuch, Leechburg, PA (US)

(73) Assignee: Kennametal Inc., Latrobe, PA (US)

(21) Appl. No.: 19/055,659

(22) Filed: Feb. 18, 2025

Related U.S. Application Data
(63) Continuation of application No. 18/108,426, filed on Feb. 10, 2023.

(51) Int. Cl. E21C 35/197

(52) U.S. Cl. CPC E21C 35/197

(57) ABSTRACT

An indexable earth cutting tool system includes an indexable earth cutting tool assembly and a support block. The earth cutting tool assembly includes a cutting tool, such as a conical cutting bit, and a sleeve having a bore for receiving a shank of the conical cutting bit. The conical cutting bit can be a rotatable conical cutting bit or a static conical cutting bit. In one aspect, the sleeve is a dual indexable sleeve with the bore having a cylindrical portion and a non-cylindrical portion that accepts both the rotatable conical cutting bit and the static (i.e., non-rotatable) conical cutting bit. In another aspect, the sleeve is a static indexable sleeve with the bore having only a non-cylindrical cross section that only accepts the static conical cutting bit.

### FIELD

The present description pertains to earth working machines for excavating different types of substances, such as, rock or dirt, and which includes an earth cutting tool system comprising a cutting bit, such as a rotatable conical bit, or a non-rotatable, indexable cutting bit, such as a spade bit, disposed within a dual indexable sleeve or an indexable sleeve that is received within a support block.

### BACKGROUND

Many coal mining and/or construction systems generally include a plurality of cutting tools, such as cutting bits, for cutting into either hard material, such as concrete, asphalt, or rock, or into soft material, such as dirt. The cutting bits are held by support blocks and sleeves. The support blocks are generally welded to a cutting chain, drum or wheel, and the blocks may be arranged so that alternating bits project from opposite sides of or staggered positions on the wheel, drum or chain.

Conical cutting bits generally have a shank with a cylindrical outer surface and are rotatable within the sleeve. Additionally, depending upon the application, it may be desirable to use a hybrid cutting bit having properties of both the rotating conical bit and the non-rotating (i.e., static) spade bit.

Depending on the cutting conditions, rotating or static earth cutting tools will be preferred over the other system. One drawback to a static cutting system is that the full circumference of the hard wear tip of the cutting tool is not utilized because of the cutting tool's inability to rotate. Accordingly, those skilled in the art continue with research and development in the field of toolholder assemblies.

### SUMMARY

The problem of utilizing the full circumference of the hard wear tip of a cutting tool is solved by providing an earth cutting tool assembly comprising a dual indexable sleeve having a bore with a first portion having a cylindrical cross section and a second portion with a non-cylindrical cross section that accepts both a rotatable cutting tool and a static indexable cutting tool. In addition, the problem is solved by providing an earth cutting tool assembly comprising a static indexable sleeve having a bore with a non-cylindrical cross section that accepts only a static indexable cutting tool.

An earth cutting tool system of the present disclosure comprises of a tool, sleeve, and block where the tool and sleeve has a non-cylindrical cross section. In one example, the non-cylindrical cross section comprises a polygonal cross section. The cutting tool and sleeve either have only a polygonal cross section, which only accepts static tools, or a cylindrical cross section followed by a polygonal cross section, which accepts either static and/or rotating cutting tools. The polygonal cross section allows the cutting tool to be inserted, used in cutting, removed, rotated, and reinserted in order to utilize the full circumference of the wear tip. The number of reinsertions is dictated by the number of sides of the polygon, for example, hexagon (i.e., six sides), octagon (i.e., eight sides), and the like. The cutting bit can be reused until the cutting tip of the cutting bit has fully worn away.

The earth cutting tool system of the present disclosure improves upon other previously known static retention methods. Examples include, but aren't limited to, press fits, one-piece tool/sleeve designs, welded solutions, and the like. The problem with these other methods is that only one portion of the hard wear tip is worn away during operation. This means the full life (i.e., full circumference) of the wear surface is not being utilized. In addition, the dual indexable sleeve having a cylindrical cross section followed by a polygonal cross section design adds in the additional benefit of freely switching between rotating and static cutting tool systems.

In one aspect, an indexable earth cutting tool assembly comprises a cutting tool having a shank and a dual indexable sleeve having a bore extending from a top surface to a bottom surface for receiving the shank of the cutting tool. The bore of the dual indexable sleeve has a first portion with a cylindrical cross section and extending a predetermined length from the top surface, and wherein the bore has a second portion with a non-cylindrical cross section and extending from the first portion to the bottom surface,

In yet another aspect, an indexable earth cutting tool assembly comprises a static conical cutting bit having a shank; and a sleeve having a bore extending from a top surface to a bottom surface for receiving the shank of the static conical cutting bit. The sleeve comprises a static indexable sleeve. The bore has a non-cylindrical cross section extending entirely from the top surface to the bottom surface. The shank of the static conical cutting bit has a non-cylindrical cross section received within the bore of the static indexable sleeve.

In still yet another aspect, a dual indexable sleeve for receiving a shank of a cutting tool of an indexable earth cutting tool assembly, the dual indexable sleeve comprising a flange portion, a shank portion and a bore extending from a top surface to a bottom surface. The bore has a first portion with a cylindrical cross section and extending a predetermined length from the top surface. The bore has a second portion with a non-cylindrical cross section and extending from the first portion to the bottom surface.

Other embodiments of the disclosed an earth cutting tool system comprising an earth cutting tool assembly will become apparent from the following detailed description, the accompanying drawings and the appended claims.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is a perspective view of an exemplary earth cutting tool system comprising a support block and an earth cutting tool assembly including a cutting bit and a sleeve according to the present description.

FIG. 2 is sectional view of the earth cutting tool system taken along line 2-2 of FIG. 1.

FIG. 3 is a side view of an earth cutting tool assembly with a dual indexable sleeve according to the present description.

FIG. 4 is a sectional view of the earth cutting tool assembly taken along line 4-4 of FIG. 3.

FIG. 5 is a side view of a rotatable conical cutting bit of the earth cutting tool assembly of FIG. 3 according to the present description.

FIG. 6 is a sectional view of the rotatable conical cutting bit taken along line 6-6 of FIG. 5.

FIG. 7 is a side view of a dual indexable sleeve according to the present description.

FIG. 8 is a sectional view of the dual indexable sleeve taken along line 8-8 of FIG. 7.

FIG. 9 is a top view of the dual indexable sleeve of FIG. 7.

FIG. 10 is a bottom view of the dual indexable sleeve of FIG. 7.

FIG. 11 is a sectional view of an earth cutting tool assembly with the dual indexable sleeve taken along line 11-11 of FIG. 3.

FIG. 12 is a side view of a static conical cutting bit of the earth cutting tool assembly of FIG. 3 according to the present description.

FIG. 13 is a sectional view of the static conical cutting bit taken along line 13-13 of FIG. 12.

FIG. 14 is a side view of an earth cutting tool assembly with a static indexable sleeve according to the present description.

FIG. 15 is a sectional view of the earth cutting tool assembly taken along line 15-15 of FIG. 14.

FIG. 16 is a side view of a static conical cutting bit of the earth cutting tool assembly of FIG. 14 according to the present description.

FIG. 17 is a sectional view of the static conical cutting bit taken along line 17-17 of FIG. 16.

FIG. 18 is a side view of a static indexable sleeve according to the present description.

FIG. 19 is a sectional view of the static indexable sleeve taken along line 19-19 of FIG. 18.

FIG. 20 is a top view of the static indexable sleeve of FIG. 18.

FIG. 21 is a bottom view of the static indexable sleeve of FIG. 18.

### DETAILED DESCRIPTION

Referring to the drawings wherein like reference characters designate like elements there is shown an earth cutting tool system 10 comprising an earth cutting tool assembly 12 according to the present description.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Throughout the text and the claims, use of the word “about” in relation to a range of values (e.g., “about 22 to 35 wt %”) is intended to modify both the high and low values recited, and reflects the penumbra of variation associated with measurement, significant figures, and interchangeability, all as understood by a person having ordinary skill in the art to which this invention pertains.

For purposes of this specification (other than in the operating examples), unless otherwise indicated, all numbers expressing quantities and ranges of ingredients, process conditions, etc. are to be understood as modified in all instances by the term “about”. Accordingly, unless indicated to the contrary, the numerical parameters set forth in this specification and attached claims are approximations that can vary depending upon the desired results sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Further, as used in this specification and the appended claims, the singular forms “a”, “an” and “the” are intended to include plural referents, unless expressly and unequivocally limited to one referent.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements including that found in the measuring instrument. Also, it should be understood that any numerical range recited herein is intended to include all sub-ranges subsumed therein. For example, a range of “1 to 10” is intended to include all sub-ranges between and including the recited minimum value of 1 and the recited maximum value of 10, i.e., a range having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

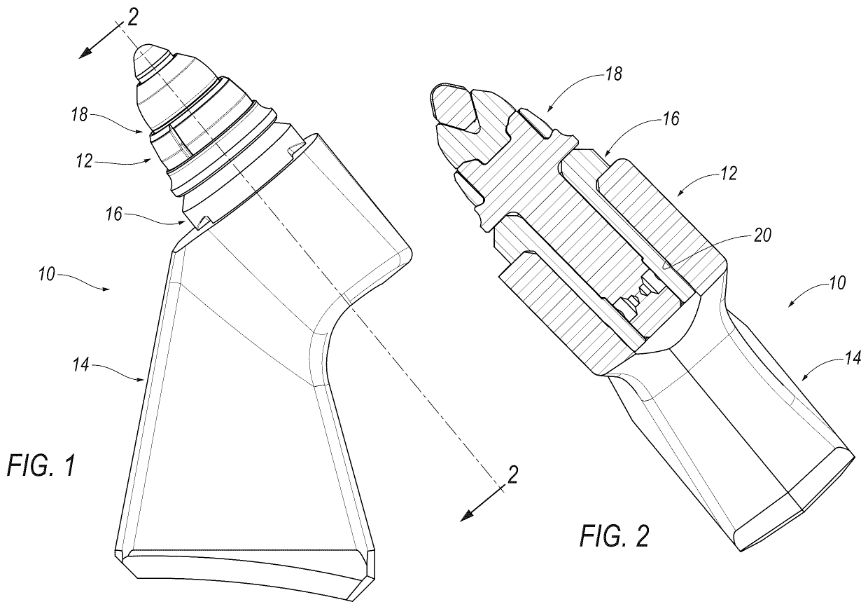

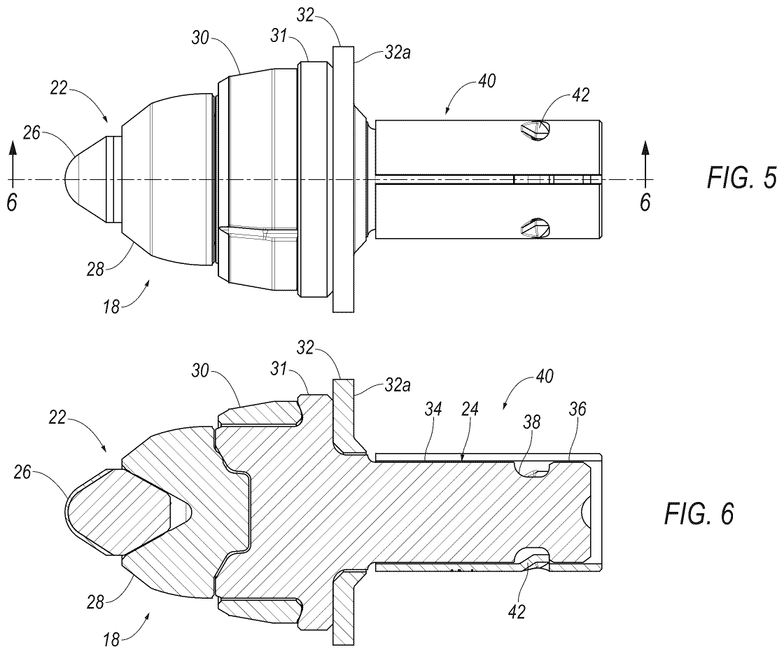

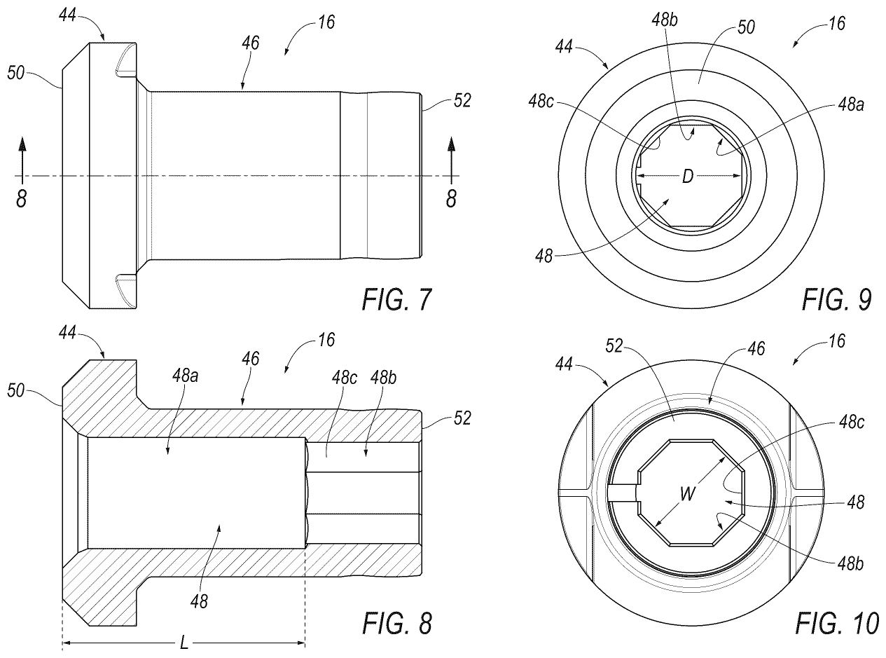

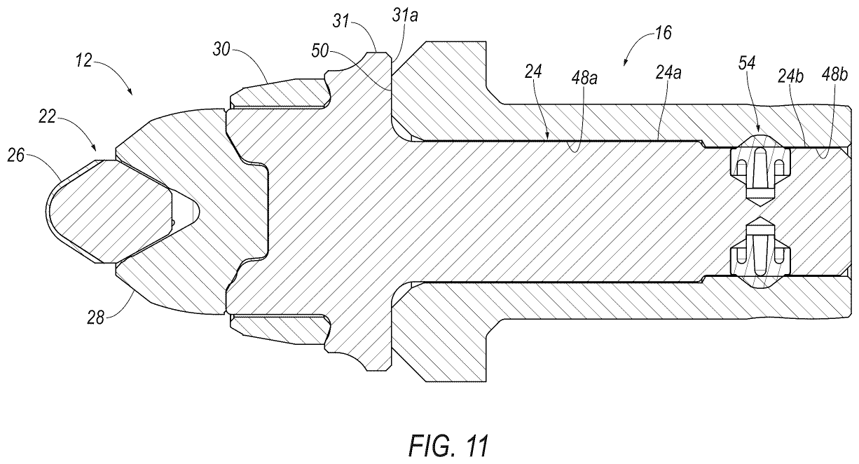

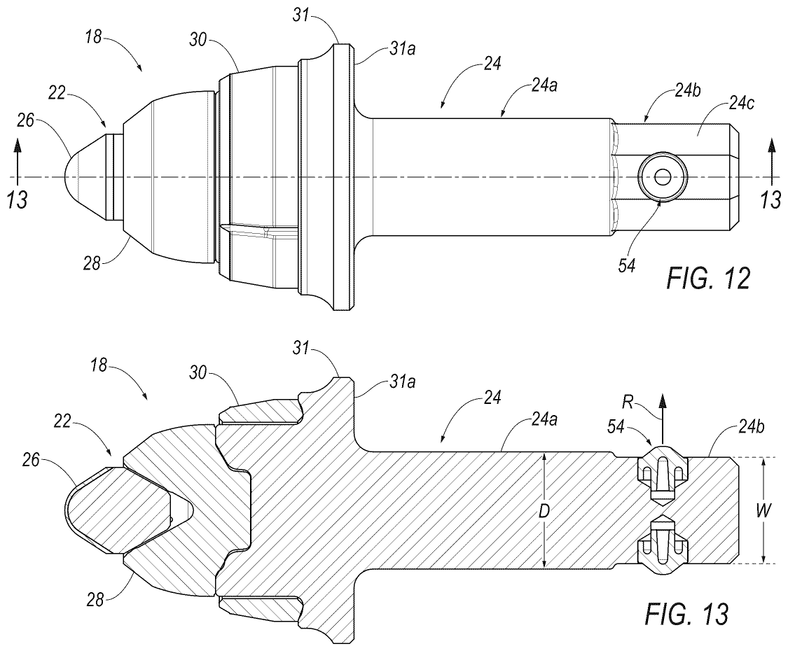

Referring now to FIGS. 1 and 2, the earth cutting tool system 10 comprises the earth cutting tool assembly 12 and a support block 14 for rotatably supporting the earth cutting tool assembly 12. In general, the earth cutting tool assembly 12 comprises a sleeve 16 for receiving the shank 24 of a cutting tool 18. The cutting tool 18 can be either a rotatable conical cutting tool 18 or static (i.e., non-rotatable) cutting tool 18. For example, in the embodiment shown in FIGS. 1 and 2, the earth cutting tool assembly 12 comprises a dual indexable sleeve 16 (FIGS. 7-10) for receiving a static (i.e., non-rotating) conical cutting bit 18 (FIGS. 11-13) or a rotatable conical cutting bit 18 (FIGS. 4-6). The support block 14 is standard with a cylindrical bore 20 that accepts the dual indexable sleeve 16. It will be appreciated that the invention is not limited by the type of cutting tool, such as a rotatable conical cutting bit or a static conical cutting bit, and that the principles of the invention can be practiced with other types of cutting tools, such as a spade bit, and the like.

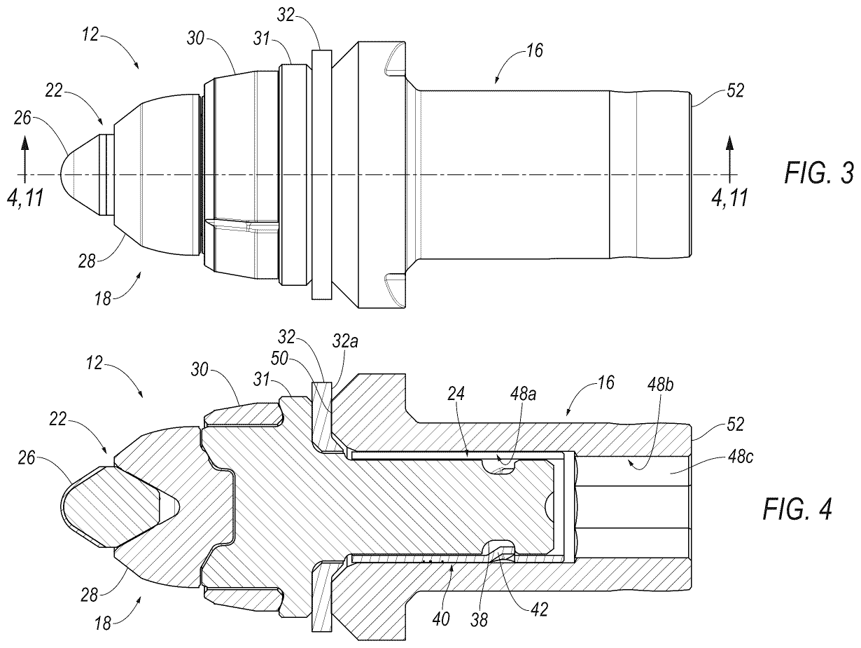

Referring now to FIGS. 3-10, an earth cutting tool assembly 12 is shown according to one aspect of the description. In this aspect, the earth cutting tool assembly 12 comprises a dual indexable sleeve 16 for mounting and securing to the support block 14 and a cutting tool 18 comprising a rotatable conical cutting bit received within a bore of the dual indexable sleeve 16.

As shown in FIGS. 3-6, the rotatable conical cutting bit 18 includes a forward cutting end 22 and a shank 24. The forward cutting end 22 includes a hard wear tip or hardened nose 26, preferably made of a hard wear-resistant material, such as one of a number of refractory coated cemented carbide materials, which are well known in the art. The cemented carbide may include tungsten carbide, titanium carbide or TIC—TIN. The forward cutting end 22 also includes a tapered portion 28, an enlarged portion 30, a flange portion 31, and a washer 32, which separates the enlarged portion 30 and the shank 24. The shank 24 has an upper cylindrical portion 34 and a lower cylindrical portion 36 separated by a circumferential groove 38.

The rotatable conical cutting bit 18 also includes a retainer clip 40 disposed about the shank 24 of the rotatable conical cutting bit 18. The retainer clip 40 includes at least one tab 42 received within the circumferential groove 38 formed in the shank 24 of the rotatable conical cutting bit 18 for preventing unwanted axial movement of the rotatable conical cutting bit 18, while allowing the rotatable conical cutting bit 18 to rotate when the earth cutting tool assembly 12 is received in the cylindrical bore 20 of the support block 14.

As shown in FIGS, 7-10, the dual indexable sleeve 16 of the earth cutting tool assembly 12 is shown according to an aspect of the disclosure. The sleeve 16 has a flange portion 44, a shank portion 46 and a bore 48 extending from a top surface 50 to a bottom surface 52 for receiving the shank 24 of the cutting tool 18. The dual indexable sleeve 16 accepts both types of cutting tools 18, i.e., the rotatable conical cutting bit 18 and the static conical cutting bit 18. To accomplish this, the bore 48 has a first cylindrical portion 48a with a substantially cylindrical cross section that extends a predetermined length, L, from the top surface 50, and a second non-cylindrical portion 48b with a non-cylindrical cross section that is compatible with the cross-sectional shape of the second non-cylindrical portion 24b of the shank 24 of the cutting tool 18 and extending from the first portion 48a to the bottom surface 52. The predetermined length, L, is sufficient to accommodate various lengths of the shank 24 of the cutting tool 18. In the illustrated embodiment, the non-cylindrical cross section comprises a polygonal cross section, and specifically an octagon with eight flat indexing surfaces 48c. However, it will be appreciated that the invention is not limited by the non-cylindrical cross section being octagonal, and that the invention can be practiced with a polygon having any desirable number of sides, for example, four, five, six, seven, nine, ten, and the like. In addition, the non-cylindrical cross section can be oval, elliptical, and the like, rather than polygonal in cross section.

It should be noted that the first cylindrical portion 48a of the bore 48 bas a maximum diameter, D, and the second non-cylindrical portion 48b of the bore 48 has a maximum width, W, such that the maximum width, W, of the second non-cylindrical portion 48a is less than or equal to the maximum diameter, D, of the first cylindrical portion 48a of the bore 48.

When installed, the shank 24 of the rotatable conical cutting bit 18 is received only within the first portion 48a of the bore 48 of the dual indexable sleeve 16 and is freely rotatable within the first portion 48a of the bore 48, as shown in FIG. 4. In addition, the top surface 50 of the sleeve 16 contacts a bottom surface 32a of the washer 32 when the shank 24 of the cutting tool 18 is received only within the cylindrical first portion 48a of the bore 48 of the sleeve 16,

As mentioned above, the dual indexable sleeve 16 accepts both types of cutting tools 18 (i.e., rotatable conical cutting bit and static conical cutting bit).

Referring now to FIGS. 11-13, the cutting tool 18 of the earth cutting tool assembly 12 comprises a static (i.e., non-rotatable) conical cutting bit. The shank 24 of the static conical cutting bit 18 has a first cylindrical portion 24a with a substantially cylindrical cross section received within the first cylindrical portion 48a of the bore 48 of the dual indexable sleeve 16 and a second non-cylindrical portion 24b with a non-cylindrical cross section received within the second non-cylindrical portion 48b of the bore 48 of the dual indexable sleeve 16. In the illustrated embodiment, the non-cylindrical cross section comprises a polygonal cross section, and specifically an octagon having eight flat indexing surfaces 24c. However, it will be appreciated that the invention is not limited by the non-cylindrical cross section being octagonal, and that the invention can be practiced with a polygon having any desirable number of flat indexing surfaces 24c, for example, four, five, six, seven, nine, ten, and the like, In addition, the non-cylindrical cross section can be oval, elliptical, and the like, rather than polygonal in cross section.

Similar to the bore 48 of the dual indexable sleeve 16, the first cylindrical portion 24a of the shank 24 has a maximum diameter, D, and the second non-cylindrical portion 24b of the shank 24 has a maximum width, W, such that the maximum width, W, of the second non-cylindrical portion 24a is less than or equal to the maximum diameter, D, of the first cylindrical portion 24a of the bore 48.

The static conical cutting bit 18 includes a button retainer 54 that elastically deforms and provides a force in a radial direction, R, against the dual indexable sleeve 16 to prevent unwanted axial movement of the static conical cutting bit 18 when the second non-cylindrical portion 24b of the shank 24 of the static conical cutting bit 18 is received in the second non-cylindrical portion 48b of the bore 48 of the dual indexable sleeve 16. The static conical cutting bit 18 can be indexed by removing, rotating, and reinserting the static conical cutting bit 18 in the sleeve 16 in order to utilize the full circumference of the hardened nose 26.

It should be understood that the button retainer 54 is only one type of retention method, and that the invention can be practiced with other types of retention methods, such as, a pin, an external retainer clip, and the like.

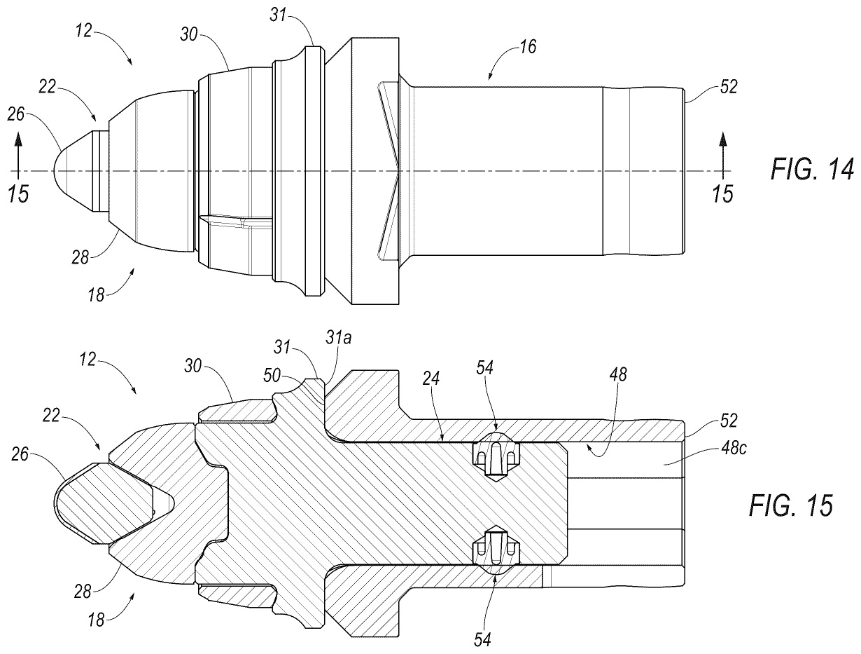

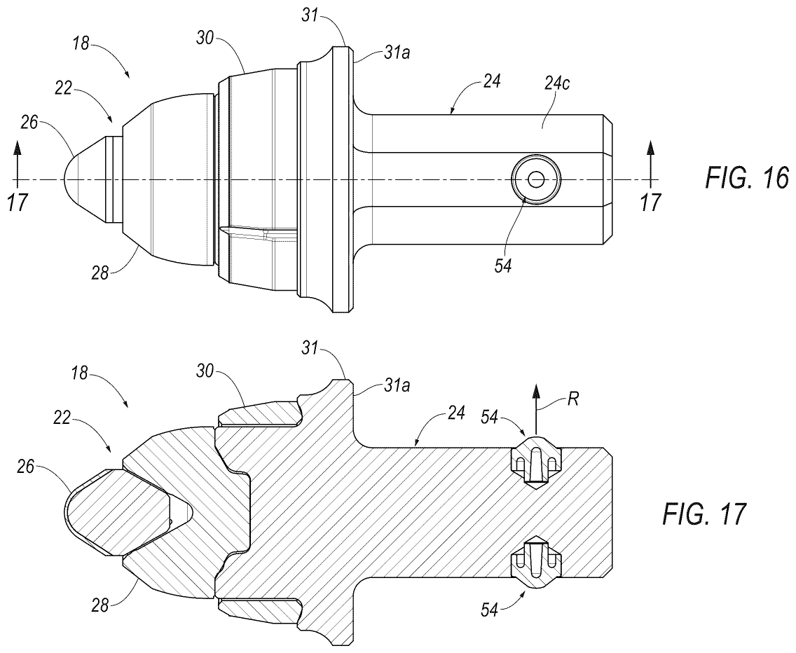

Referring now to FIGS. 14-21, an earth cutting tool assembly 12 is shown according to another aspect of the description. In this aspect, the earth cutting tool assembly 12 comprises a static indexable sleeve 16 and a cutting tool 18 comprising a static (i.e., non-rotatable) conical cutting bit for mounting and securing to the support block 14.

In the earlier embodiment shown in FIGS. 11-13, the shank 24 of the static conical cutting bit 18 comprises a first cylindrical portion 24a and a second non-cylindrical portion 24b with indexing surfaces 24c. However, in this aspect, the shank 24 does not include the first cylindrical portion 24a, but the entire shank 24 of the static conical cutting bit 18 has a non-cylindrical cross section with indexing surfaces 24c that is received within the bore 48 of the static indexable sleeve 16. As in the earlier embodiment, the non-cylindrical cross section comprises a polygonal cross section, and specifically an octagon having eight flat indexing surfaces 16a. However, it will be appreciated that the invention is not limited by the non-cylindrical cross section being octagonal, and that the invention can be practiced with a polygon having any desirable number of sides, for example, four, five, six, seven, nine, ten, and the like. In addition, the non-cylindrical cross section can be oval, elliptical, and the like, rather than polygonal in cross section.

As shown in FIGS. 15-17, the static conical cutting bit 18 includes a button retainer 54 that elastically deforms and provides a force in a radial direction, R, against the static indexable sleeve 16 to prevent unwanted axial movement of the static conical cutting bit 18 when the shank 24 of the static conical cutting bit 18 is received in the static indexable sleeve 16.

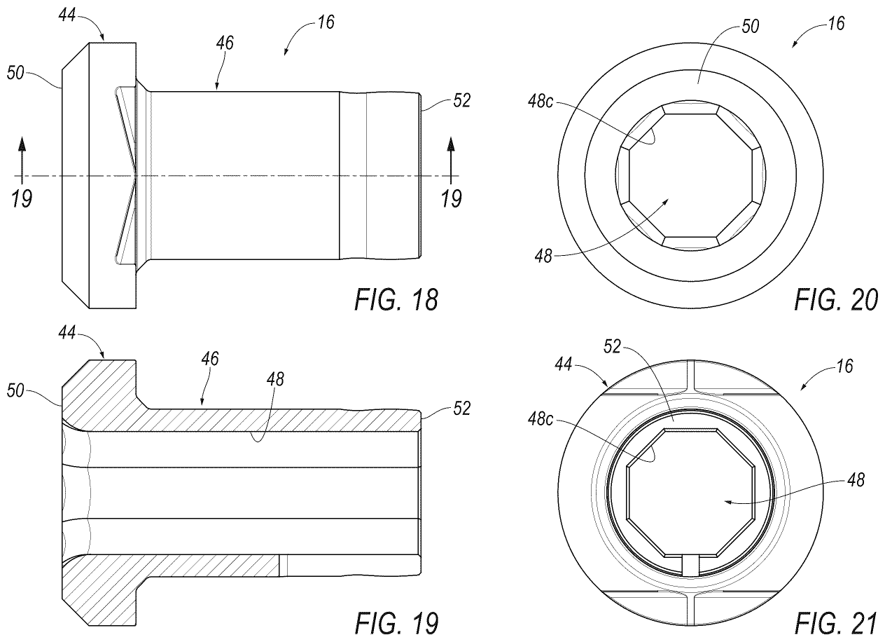

As shown in FIGS. 18-21, the static indexable sleeve 16 has a flange portion 44, a shank portion 46 and a bore 48 extending from a top surface 50 to a bottom surface 52 for receiving the non-cylindrical shank 24 of the static conical cutting bit 18. Unlike the dual indexable sleeve 16 discussed above, the static indexable sleeve 16 accepts only the static conical cutting bit 18. To this end, the bore 48 has a substantially non-cylindrical cross section that is compatible with the cross-sectional shape of the shank 24 of the static conical cutting bit 18 and extends substantially the entire length, L, of the sleeve 16 from the top surface 50 to the bottom surface 52. In the illustrated embodiment, the non-cylindrical cross section comprises a polygonal cross section, and specifically an octagon having eight flat indexing surfaces 48c. However, it will be appreciated that the invention is not limited by the non-cylindrical cross section being octagonal, and that the invention can be practiced with a polygon having any desirable number of flat indexing surfaces 24c, for example, four, five, six, seven, nine, ten, and the like, In addition, the non-cylindrical cross section can be oval, elliptical, and the like, rather than polygonal in cross section.

When installed, the top surface 50 of the sleeve 16 contacts a bottom surface 31a of the flange portion 31 of the static conical cutting bit 18 when the shank 24 of the cutting tool 18 is received within the bore 48 of the sleeve 16. The static conical cutting bit 18 can be indexed by removing, rotating, and reinserting the static conical cutting bit 18 in the sleeve 16 in order to utilize the full circumference of the hardened nose 26.

Although various embodiments of the disclosed indexable earth cutting tool assembly have been shown and described, modifications may occur to those skilled in the art upon reading the specification. The present application includes such modifications and is limited only by the scope of the claims.

What is claimed is:

1. An indexable earth cutting tool assembly, comprising:
a rotatable conical cutting bit having a shank;
a dual indexable sleeve having a bore extending from a top surface to a bottom surface for receiving the shank of the rotatable conical cutting bit; and
a retainer clip disposed about the shank of the rotatable cutting bit.
wherein the retainer clip includes a tab received within a circumferential groove formed in the shank of the rotatable conical cutting bit for preventing unwanted axial movement of the rotatable conical cutting bit when the rotatable conical cutting bit is received in the bore of the dual indexable sleeve,

2. An indexable earth cutting tool assembly, comprising:
a dual indexable sleeve having a bore extending from a top surface to a bottom surface; and
a static conical cutting bit,
wherein a shank of the static conical cutting bit has a first portion with a cylindrical cross section received within a first portion of a bore of a dual indexable sleeve and a second portion with a non-cylindrical cross section received within a second portion of the bore of the dual indexable sleeve.

2. indexable earth cutting tool assembly of claim 2, wherein the non-cylindrical cross section of the bore is polygonal having a plurality of flat indexing surfaces.

4. The indexable earth cutting tool assembly of claim 2, wherein the first portion of the bore bas a maximum diameter, and the second portion of the bore has a maximum width such that the maximum width of the second portion is less than or equal to the maximum diameter of the first portion of the bore.

5. The indexable earth cutting tool assembly of claim 2, wherein the shank of the static conical cutting bit further comprises a button retainer that elastically deforms and provides a force in a radial direction against the dual indexable sleeve to prevent unwanted axial movement of the static conical cutting bit when the second portion of the shank of the static conical cutting bit is received in the second portion of the bore of the dual indexable sleeve.

6. An indexable earth cutting tool assembly, comprising:
a static conical cutting bit having a shank; and
a sleeve having a bore extending from a top surface to a bottom surface for receiving the shank of the static conical cutting bit,
wherein the sleeve comprises a static indexable sleeve,
wherein the bore has a non-cylindrical cross section extending entirely from the top surface to the bottom surface, and
wherein the shank of the static conical cutting bit has a non-cylindrical cross section received within the bore of the static indexable sleeve.

7. The indexable earth cutting tool assembly of claim 6, wherein the shank of the static conical cutting bit further comprises a button retainer that elastically deforms and provides a force in a radial direction against the static indexable sleeve to prevent unwanted axial movement of the static conical cutting bit when the shank of the static conical cutting bit is received in the bore of the static indexable sleeve,

6. An indexable earth cutting tool assembly of claim 6, wherein the non-cylindrical cross section of the bore is polygonal having a plurality of flat indexing surfaces.

9. An indexable earth cutting tool assembly, comprising:
a dual indexable sleeve having a bore extending from a top surface to a bottom surface; and
a static conical cutting bit having a shank,
wherein the shank of the static conical cutting bit has a non-cylindrical cross section received within the bore of the dual indexable sleeve.
